(19) United States
(12) Patent Application Publication
(10) Pub. No.: US 2017/0289758 A1
(43) Pub. Date: Oct. 5, 2017

(54) TECHNOLOGIES FOR PREVENTING LOSS OF COMPUTE DEVICES IN A CLUSTER

(71) Applicant: Intel Corporation, Santa Clara, CA (US)

(72) Inventors: Lital Shiryan, Ramat Gan (IL); Tamir Damian Munafo, Har-Hotzbim (IL)

(21) Appl. No.: 15/083,751

(22) Filed: Mar. 29, 2016

(51) Int. Cl. H04W 4/02; H04L 12/26

(52) U.S. Cl. CPC H04W 4/023; H04L 43/16

(57) ABSTRACT

Technologies for preventing loss of compute devices in a cluster include a compute device to receive motion sensor data from at least one secondary compute device of a cluster, wherein the cluster comprises a plurality of compute devices that includes the at least one secondary compute device and the compute device, and wherein the compute device is a primary compute device of the cluster. The compute device is further to determine, based on the motion sensor data, whether one or more compute devices of the cluster has moved away from the cluster, and notify, in response to a determination that the one or more compute devices of the cluster has moved away from the cluster, a user of the compute device that the one or more compute devices has moved away from the cluster. Other embodiments are described.

### BACKGROUND

Today, many people carry a variety of electronic devices that have sensing and communication capabilities. In the future, the set of electronic devices carried by people will likely expand to include electronic wallets, electronic credit cards within a wallet, and other devices with sensing and communication capabilities. With such a collection of devices being carried by a person at any given time, it is likely that the person will lose track of one or more devices, due to misplacement or theft.

Conventional approaches to allow a user to track a device require the user to attach an external token to the device. Typically, the external token includes a mechanism to report its geographic location to a tracking device, or to raise an alert if the device has lost contact with a tracking device. The tokens perform these functions without regard to the overall context of the devices, such as their relative motion to each other or their environment, thereby making their location reporting and alert raising operations inappropriate in some circumstances and using unnecessary amounts of power.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for preventing loss of compute devices in a cluster;

FIG. 2 is a simplified block diagram of at least one embodiment of a compute device of the system of FIG. 1;

FIG. 3 is a simplified block diagram of at least one embodiment of an environment that may be established by a compute device of FIGS. 1 and 2;

FIGS. 4-5 are a simplified flow diagram of at least one embodiment of a method for configuring a cluster of the compute devices of FIGS. 1 and 2;

FIGS. 6-8 are a simplified flow diagram of at least one embodiment of a method for monitoring the compute devices of FIGS. 1 and 2; and

FIGS. 9-10 are a simplified flow diagram of at least one embodiment of a method for operating as a secondary compute device in the cluster of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

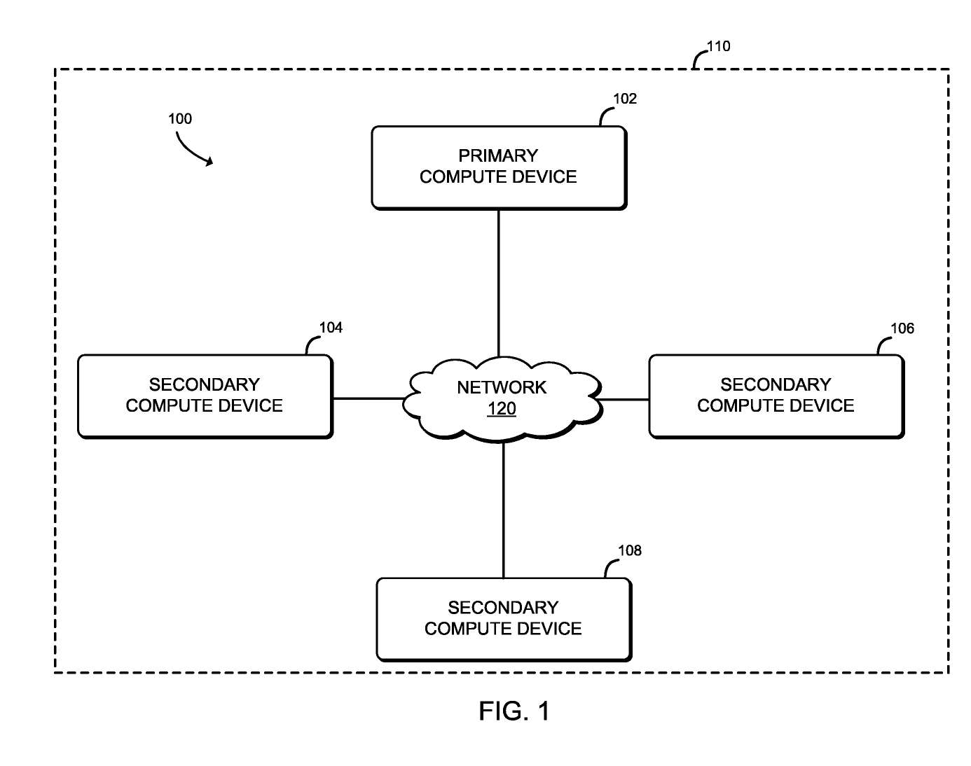

Referring now to FIG. 1, in an illustrative embodiment, a system for preventing loss of compute devices includes multiple compute devices 100 organized in a cluster 110. The compute devices 100 include a primary compute device 102 and secondary compute devices 104, 106, 108. In operation, the illustrative primary compute device 102 is configured to be in wireless communication with each of the secondary compute devices 104, 106, 108 via a network 120. The illustrative primary compute device 102 is configured to receive motion sensor data from each secondary compute device 104, 106, 108 indicative of the spatial movement of each secondary compute device 104, 106, 108. The illustrative primary compute device 102 is further configured to determine whether the spatial movement of one or more compute devices 100 in the cluster 110 is directed away from the cluster, indicating that the compute device 100 is being separated from the cluster 110. In other words, the primary compute device 102 is illustratively configured to differentiate movement of all of the compute devices 100 in the same direction from motion sensor data indicative of one or more of the compute devices 100 being separated from the rest of the cluster 110. Further, the illustrative primary compute device 102 is configured to determine whether the cluster 110 is in a predefined spatial zone in which tracking of the movement of the compute devices 100 has been defined to be appropriate or not. By determining these aspects of the context of the compute devices 100 in the cluster 110, the primary compute device 102 is able to more intelligently determine whether additional device tracking, security, and recovery functions, which may be otherwise inappropriate, should be activated.

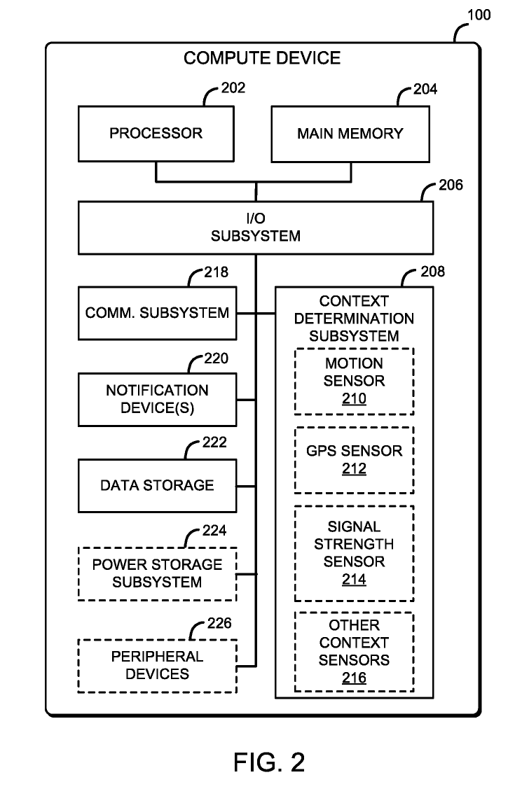

Referring now to FIG. 2, each compute device 100 of the cluster 110 may be embodied as any type of compute device capable of performing the functions described herein. For example, in some embodiments, each compute device 100 may be embodied as, without limitation, a computer, a wearable compute device, a smartphone, a tablet computer, a consumer electronic device, a smart appliance, a laptop computer, a notebook computer, and/or any other computing device capable of performing functions to aid in preventing the loss (e.g., misplacement, theft, etc.) of a compute device 100 of the cluster 110, as described herein. As shown in FIG. 1, the illustrative compute device 100 includes a processor 202, a main memory 204, an input/output subsystem 206, a context determination subsystem 208, a communication subsystem 218, and one or more notification devices 220. Of course, the compute device 100 may include other or additional components, such as those commonly found in a computer that may travel with a person (e.g., various input/output devices, one or more power storage devices, etc.), in other embodiments. Additionally, in some embodiments, one or more of the illustrative components may be incorporated in, or otherwise from a portion of, another component. For example, the memory 204, or portions thereof, may be incorporated in the processor 202 in some embodiments.

The processor 202 may be embodied as any type of processor capable of performing the functions described herein. For example, the processor may be embodied as a single or multi-core processor(s) having one or more processor cores, a digital signal processor, a microcontroller, or other processor or processing/controlling circuit. Similarly, the main memory 204 may be embodied as any type of volatile or non-volatile memory or data storage capable of performing the functions described herein. In operation, the main memory 204 may store various data and software used during operation of the compute device 100 such as cluster membership data, device context data, defined zone data, operating systems, applications, programs, libraries, and drivers. The main memory 204 is communicatively coupled to the processor 202 via the I/O subsystem 206.

The I/O subsystem 206 may be embodied as circuitry and/or components to facilitate input/output operations with the processor 202, the main memory 204, and other components of the compute device 100. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 202, the memory 204, and other components of the compute device 100, on a single integrated circuit chip.

The compute device 100 additionally includes the context determination subsystem 208. The illustrative context determination subsystem 208 includes one or more motion sensors 210 to detect movement of the compute device 100 in three dimensions and to detect the speed of the movement. Further, the illustrative context determination subsystem 208 includes a global positioning system (GPS) sensor 212 to determine present geographic coordinates of the compute device 100 based on signals from GPS satellites. The illustrative context determination subsystem 208 also includes a signal strength sensor 214 to determine the strength of signals from access points, cellular towers, or other devices that broadcast signals wirelessly and to identify the devices and/or wireless networks associated with the devices. By comparing the strength of a signal associated with one wireless network with the signal strengths associated with other detected wireless networks, the illustrative determination subsystem is configured to determine a location of the compute device 100. The context determination subsystem 208 may additionally or alternatively include one or more other context sensors 216 configured to detect and provide information indicative of the movement or location (i.e., context) of the compute device 100.

The illustrative compute device 100 additionally includes the communication subsystem 218. The communication subsystem 218 may be embodied as one or more devices and/or circuitry for enabling communications with one or more other compute devices 100 over a network. The communication subsystem 218 may be configured to use any suitable communication protocol to communicate with other devices including, for example, wireless data communication protocols, cellular communication protocols, and/or wired communication protocols.

The illustrative compute device 100 may also include one or more notification devices 220. One or more of the notification devices 220 may be embodied as any type of display on which information may be displayed to a user of the compute device 100. The display may be embodied as, or otherwise use, any suitable display technology including, for example, a liquid crystal display (LCD), a light emitting diode (LED) display, a cathode ray tube (CRT) display, a plasma display, and/or other display usable in a compute device. The display may include a touchscreen sensor that uses any suitable touchscreen input technology to detect the user's tactile selection of information displayed on the display including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors. The one or more notification devices 220 may additionally or alternatively include devices configured to generate audible signals, such as alarms, speech, or other sounds. Additionally or alternatively, the notification devices 220 may include a tactile notification device capable of producing a tactile signal, such as vibration, to be detected by a user of the compute device 100.

The compute device 100 may additionally include a data storage device 222 which may be embodied as any type of device or devices configured for short-term or long-term storage of data such as, for example, memory devices and circuits, memory cards, hard disk drives, solid-state drives, or other data storage devices. The data storage device 222 may store cluster membership data, device context data, defined zone data, operating systems, applications, programs, libraries, and drivers, as described in more detail herein.

The compute device 100 may additionally include a power storage subsystem 224, which may include one or more devices (e.g., batteries) capable of storing power for use when the compute device 100 is not connected to a power source. Additionally or alternatively, the compute device 100 may include one or more peripheral devices 226. Such peripheral devices 226 may include any type of peripheral device commonly found in a compute device such as speakers, a mouse, a keyboard, and/or other input/output devices, interface devices, and/or other peripheral devices.

Referring back to FIG. 1, the network 120 may be embodied as any number of various wireless or wired networks. For example, the network 120 may be embodied as, or otherwise include, a wireless personal area network (WPAN), a wireless local area network (LAN), a wireless or wired wide area network (WAN), a cellular network, and/or a publicly-accessible, global network such as the Internet. As such, the network 120 may include any number of additional devices, such as additional computers, routers, and switches, to facilitate communications among the devices of the system.

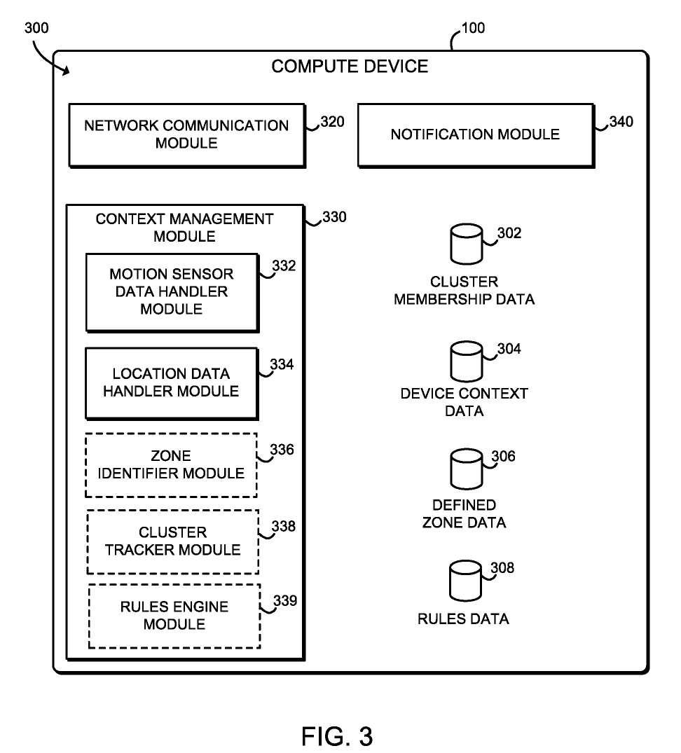

Referring now to FIG. 3, in the illustrative embodiment, each compute device 100 of the cluster 110 may establish an environment 300 during operation. The illustrative environment 300 includes a network communication module 320, a context management module 330, and a notification module 340. Each of the modules, logic, and other components of the environment 300 may be embodied as hardware, firmware, software, or a combination thereof. As such, in some embodiments, one or more of the modules of the environment 300 may be embodied as circuitry or collection of electrical devices (e.g., network communication circuitry 320, context management circuitry 330, notification circuitry 340, etc.). It should be appreciated that, in such embodiments, one or more of the network communication circuitry 320, context management circuitry 330, or notification circuitry 340 may form a portion of one or more of the processor 202, context determination subsystem 208, the communication subsystem 218, the notification devices 220, and/or other components of the compute device 100. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 202 or other components of the compute device 100.

In the illustrative environment 300, the compute device 100 includes cluster membership data 302 that includes identifiers of the compute devices 100 associated with the cluster 110, device context data 304 that includes information about the movement and location of the compute devices 100 in the cluster 110, and defined zone data 306 that includes information identifying one or more areas, such as geographic coordinates, WiFi identifiers, vehicle network identifiers, or other identifiers of areas, and indications of whether each identified area is safe (i.e., that monitoring of compute devices 100 is the cluster 110 is not appropriate) or not. Additionally, the compute device 100 includes rules data 308 that defines how the compute device 100 is to react when the compute device 100 is in each defined zone or context. The cluster membership data 302, the device context data 304, the defined zone data 306, and the rules data 308 may be accessed by the various modules and/or sub-modules of the compute device 100. It should be appreciated that the compute device 100 may include other components, sub-components, modules, sub-modules, and/or devices commonly found in a compute device, which are not illustrated in FIG. 3 for clarity of the description.

The network communication module 320, which may be embodied as hardware, firmware, software, virtualized hardware, emulated architecture, and/or a combination thereof as discussed above, is configured to manage inbound and outbound network communications to and from the compute device 100, respectively. For example, the network communication module 320 is configured to transmit and receive device context data 304 (e.g., motion sensor data, signal strength location data, GPS location data, etc.), requests, and notifications to and from other compute devices 100. In some embodiments, at least a portion of the functionality of the network communication module 320 may be performed by the communication subsystem 218 of FIG. 2.

The context management module 330, which may be embodied as hardware, firmware, software, virtualized hardware, emulated architecture, and/or a combination thereof as discussed above, is configured to determine a context (i.e., relative movement and location) of the compute devices 100 in the cluster 110 based at least in part on context data, including motion sensor data, GPS location data, signal strength location data, and/or other data generated by the context determination subsystems 208, shared by other the compute devices 100 of the cluster 110, and based on context data generated by the compute device 100 itself. In some embodiments, the context management module 330 may determine a semantic context, which, in the illustrative embodiment, is a context determined based on a combination of factors, including presently available WiFi signals, GPS location data, available Bluetooth connections, and/or other factors. The illustrative compute device 100 may use the Intel Context SDK to define and determine such semantic contexts. The illustrative context management module 330 is further configured to determine whether one or more of the compute devices 100 is moving away from or has moved out of a predefined threshold range of from the cluster 110 and take corrective actions to prevent loss of the compute devices 100 of the cluster 110. To do so, the illustrative context management module 330 includes a motion sensor data handler module 332, a location data handler module 334, a zone identifier module 336, a cluster tracker module 338, and a rules engine module 339. When operating as the primary compute device 102, the zone identifier module 336 and the cluster tracker module 338 are operational. However, in the illustrative embodiment, when the compute device 100 is acting as a secondary compute device 104, 106, 108, the zone identifier module 336 and/or cluster tracker module 338 are absent or inactive.

The illustrative motion sensor data handler module 332 is configured to generate motion sensor data from the one or more motion sensors 210 of the compute device 100. When the compute device 100 is acting as the primary compute device 102, the illustrative motion sensor data handler module 332 is further configured to compare received motion sensor data from the secondary compute devices 104, 106, 108 and determine whether the cluster 110 as a whole is moving in a particular direction or is stationary, and whether one or more of the compute devices 100, is moving away (i.e., stationary while the rest of the cluster is moving, moving while the rest of the cluster is stationary, or moving in a different direction than the cluster is moving) from the cluster 110 (i.e., because the compute device 100 in question was left behind or stolen).

Similarly, the illustrative location data handler module 334 is configured to generate location data indicative of an absolute position of the compute device 100, as distinguished from the motion sensor data, which is representative of relative movement. The illustrative location data handler module 334 generates GPS location data, signal strength location data based on detected strengths of one of more identified wireless networks at known locations, and/or other types of location data indicative of the absolute position of the compute device 100. The devices used to generate the location data may consume more power than the motion sensors 210 and, in the illustrative embodiment, are generally inactive unless the compute device 100 becomes separated from the cluster 110, as described in more detail herein. Further, when the compute device 100 is operating as the primary compute device 102, the location data handler module 334 is further configured to receive and analyze location data from one or more of the secondary compute devices 104, 106, 108 to determine their locations.

In the illustrative embodiment, the zone identifier module 336 is active when the compute device 100 is operating as the primary compute device 102 of the cluster 110. The illustrative zone identifier module 336 is configured to determine whether the compute devices 100 of the cluster 110 are located in a zone that has been defined as a safe zone in the defined zone data 306, meaning it is inappropriate to take corrective actions in response to one of the compute devices 100 becoming separated from the cluster 110. The illustrative zone identifier module 336 is configured to determine whether the cluster 110 is in a defined zone based on present geographic coordinates of the compute device 100, a detected wireless network identifier, a vehicle network identifier, or other data indicative of the location of the compute device 100.

In the illustrative embodiment, the cluster tracker module 338 is active when the compute device 100 is operating as the primary compute device 102 of the cluster 110. The illustrative cluster tracker module 338 is configured to utilize the motion sensor data handler module 332 and the location data handler module 334 to determine whether one or more compute devices 100 of the cluster 110 has moved away from the cluster 110 and to track the location of the one or more separated compute devices 100. Further, in the illustrative embodiment, the rules engine module 339 is configured to determine how the compute device 100 is to operate in the defined zones or contexts (i.e., the defined zone data 306).

It should be appreciated that each of the motion sensor data handler module 332, the location data handler module 334, the zone identifier module 336, the cluster tracker module 338, and the rules engine module 339 of the context management module 330 may be separately embodied as hardware, firmware, software, virtualized hardware, emulated architecture, and/or a combination thereof. For example, the motion sensor data handler module 332 may be embodied as a hardware component, while the location data handler module 334, the zone identifier module 336, the cluster tracker module 338, and the rules engine module 339 are embodied as virtualized hardware components or as some other combination of hardware, firmware, software, virtualized hardware, emulated architecture, and/or a combination thereof.

The notification module 340, which may be embodied as hardware, firmware, software, virtualized hardware, emulated architecture, and/or a combination thereof as discussed above, is configured to notify a user of the compute device 100 when one of the compute devices 100 has moved away from the cluster 110. Further, the notification module 340 is configured to generate audible, visual, and/or tactile alerts that the compute device 100 has been separated from the cluster 110, to close sensitive applications when the compute device 100 has been lost or stolen, and/or to perform other actions in response to being lost or stolen, as described in more detail herein.

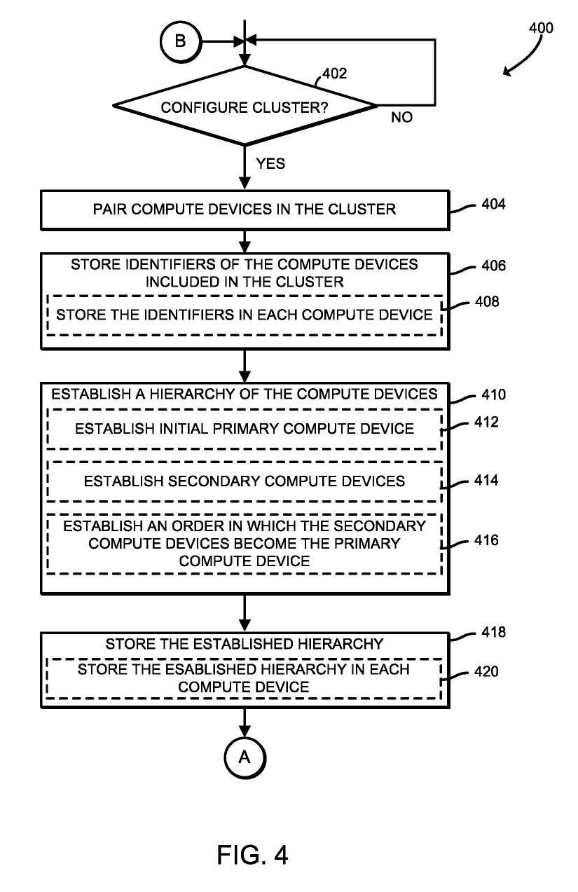

Referring now to FIG. 4, in use, the compute devices 100 of the cluster 110 may execute a method 400 for configuring the cluster 110. The method 400 begins with block 402, in which one of the compute devices 100, such as the compute device that will later be designated as the primary compute device 102, determines whether to configure the cluster 110. In the illustrative embodiment, the compute device 100 determines to configure the cluster in response to a user request provided through a graphical user interface (not shown) presented by the compute device 100. In other embodiments, the compute device 100 may determine to configure the cluster 110 in response to detecting the presence, such as a wireless data signal, of one or more other compute devices 100. Regardless, if the compute device 100 determines to configure the cluster 110, the method 400 advances to block 404 in which the compute device 100 pairs with the other compute devices 100, such as by exchanging device identifiers (e.g., names, serial numbers, media access control (MAC) addresses, etc.), communication settings, and, in some embodiments passwords, PINs, or other authorization credentials. In some embodiments, each compute device 100 pairs with each other compute device 100 in the cluster 110.

In block 406, at least one of the compute devices stores the identifiers of all of the compute devices 100 to be included in the cluster 110, as part of the cluster membership data 302. In the illustrative embodiment, as indicated in block 408, each compute device 100 stores identifiers of the compute devices 100 in the cluster 110, such that each compute device 100 is aware of the other compute devices 100 that make up the cluster 110. As described in more detail herein, this may be useful if the primary compute device 102 becomes inoperative and one of the secondary compute devices 104, 106, 108 is to subsequently act as the primary compute device 102. In block 410, the compute devices 100 establish a hierarchy. In doing so, in the illustrative embodiment, the compute devices 100 establish which of the compute devices 100 is initially to be the primary compute device 102, as indicated in block 412. The compute devices 100 may determine that the compute device 100 that initiated the pairing process is to be the primary compute device 102 and/or may designate the primary compute device 102 based on other criteria such as a comparison of which compute device 100 has the most processing power, the most capable notification system, or other factors. Further, in the illustrative embodiment, the compute devices 100 establish which of the compute devices 100 are to be the secondary compute devices 104, 106, 108, as indicated in block 414. For example, once the initial primary compute device has been established, the remaining compute devices 100 may be designated as secondary compute devices. Further, in as indicated in block 416, the compute devices 100 may establish an order in which the secondary compute devices 104, 106, 108 are to become the primary compute device 102 (i.e., if the primary compute device becomes inoperative). In block 418, at least the primary compute device 102 stores the established hierarchy in the main memory 204 and/or the data storage device 222, as part of the cluster membership data 302. In the illustrative embodiment, each of the compute devices 100 in the cluster 110 stores the established hierarchy in their respective main memory 204 and/or data storage device 222.

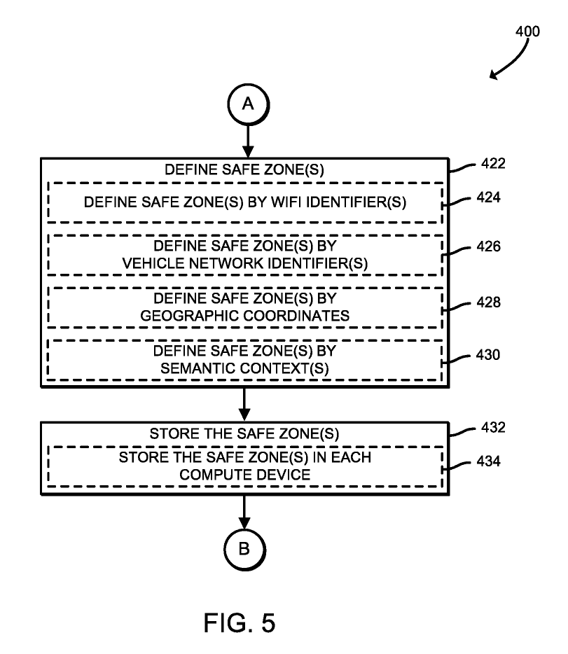

In block 422 of FIG. 5, the primary compute device 102 defines one or more safe zones, indicative of areas in which it is inappropriate to take corrective action in response to one or more of the compute devices 100 becoming separated from the cluster 110. In doing so, the primary compute device 102 may define the one or more safe zones based on a wireless network (WiFi) identifier detected by the primary compute device 102 or provided by a user of the primary compute device 102. Further, in the primary compute device 102 may define one or more safe zones by one or more vehicle network identifiers (e.g., a Bluetooth device identifier associated with a vehicle owned by a user of the cluster 110), as indicated in block 426. Additionally or alternatively, as indicated in block 428, the primary compute device 102 may define one or more safe zones by geographic coordinates that form a perimeter, or a single geographic point coupled with a defined radius. In block 430, the primary compute device 102 may define on or more safe zones by semantic contexts (i.e., combinations of available WiFi signals, Bluetooth connections, GPS location data, and/or other factors). In block 432, the primary compute device 102 stores the safe zones in the main memory 204 and/or the data storage device 222. However, as indicated in block 434, in the illustrative embodiment, all of the compute devices 100 of the cluster 110 store the safe zones in their respective main memories 204 and/or data storage devices 222 such that one of the secondary compute devices may operate as the primary compute device if the primary compute device 102 becomes inoperative.

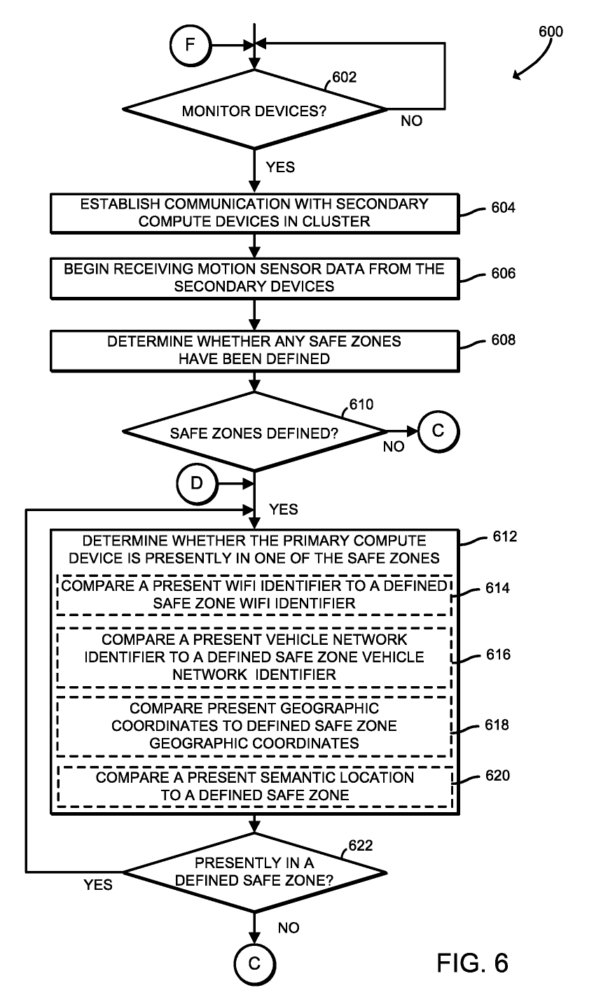

Referring now to FIG. 6, in use, the primary compute device 102 of the cluster 110 may execute a method 600 for monitoring the compute devices 100 of the cluster 110 so as to prevent loss of one or more of the compute devices 100. The method 600 begins with block 602 in which the primary compute device 102 determines whether to monitor the compute devices 100 of the cluster. Method 600 may be reached when the primary compute device 102 detects a change in state, such as changing from a stationary state to a moving state. In some embodiments, method 600 may be initiated periodically, based on the passage of time. For example, the primary compute device 102 may initiate the method 600 every sixty seconds, or at another interval, to determine the status of the compute devices 100 in the cluster 110. The method 600 may also be reached when the primary compute device 102 determines that the primary compute device 102 is leaving a safe zone. In some embodiments, the primary compute device 102 may determine to monitor the compute devices 100 in response to a user request provided through a graphical user interface or from another source. Regardless, if the primary compute device 102 determines to monitor the compute devices 100 of the cluster 110, the method 600 advances to block 604 in which the primary compute device 102 establishes communication with the secondary compute devices 104, 106, 108 of the cluster 110. In some embodiments, the primary compute device 102 is already in communication with the secondary compute devices 104, 106, 108 before making the determination of whether to monitor the secondary compute devices 104, 106, 108. Regardless, the method 600 subsequently advances to block 606 in which the primary compute device 102 begins receiving motion sensor data from the secondary compute devices 104, 106, 108. In the illustrative embodiment, the primary compute device 102 may transmit a request to each secondary compute device 104, 106, 108 to transmit their respective motion sensor data. In other embodiments, the establishment of communication, in block 604, triggers the secondary compute devices 104, 106, 108 to transmit their motion sensor data to primary compute device 102. In block 608, the primary compute device 102 determines whether any safe zones have been defined in the defined zone data 306.

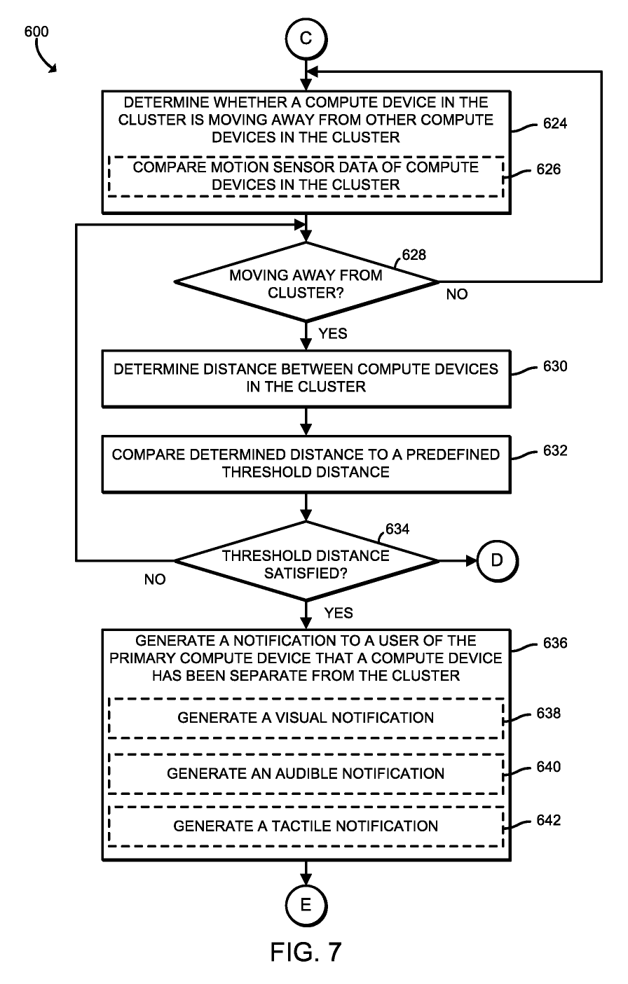

In block 610, the primary compute device 102 determines a subsequent action to take based on whether any safe zones have been defined. If the primary compute device 102 determines that at least one safe zone has been defined, the method 600 advances to block 612, in which the primary compute device 102 determines whether the primary compute device 102 is presently located in one of the safe zones. In doing so, the primary compute device 102 may compare a presently detected wireless network (WiFi) identifier to the one or more safe zones defined in the defined zone data 306 to determine whether the detected WiFi identifier matches a defined safe zone, as indicated in block 614. Additionally or alternatively, the primary compute device 102, may compare a presently detected vehicle network identifier to the one or more safe zone identifiers included in the defined zone data 306 to determine whether there is a match to a defined safe zone, as indicated in block 616. The primary compute device 102 may additionally or alternatively compare presently detected geographic coordinates of the primary compute device 102 to the defined zone data 306 to determine whether the geographic coordinates are equal to or within a predefined range of a geographic coordinates defining a safe zone. In block 620, the primary compute device 102 may determine a semantic location (i.e., semantic context) of the primary compute device 102 based on a combination of factors, including presently detected WiFi identifiers, presently detected vehicle network identifiers, presently detected geographic coordinates, other presently detected wireless signals (e.g., signals from a wireless printer, a Bluetooth speaker, one or more radio frequency (RF) tags), and/or other factors. In block 622, the primary compute device 102 determines an action to take based on whether the primary compute device 102 is in a defined safe zone. If the primary compute device 102 determines that the primary compute device 102 is in a defined safe zone, the method 600 loops back to block 612 to again determine whether the primary compute device 102 is in a safe zone. In other words, the primary compute device 102 may be moving, such it may initially be located in a safe zone, but may subsequently move out of a safe zone. If the primary compute device 102 instead determines at block 622 that it is not in a defined safe zone, or if the primary compute device 102 determines in block 610 that no safe zones have been defined, the method 600 advances to block 624 of FIG. 7, in which the primary compute device 102 determines whether a compute device 100 in the cluster 110 is moving away from other compute devices 100 in the cluster 110.

In determining whether a compute device 100 has moved away from the cluster 110, the illustrative primary compute device 102 compares motion sensor data of the compute devices 102, 104, 106, 108, as indicated in block 626. For example, the primary compute device 102 may determine that the secondary devices of the cluster 110 are stationary and that the primary compute device 102 is moving away from the cluster 110, that one or more of the secondary compute devices 104, 106, 108 is moving away from the cluster while the other compute devices 100 of the cluster are stationary, or that the majority of the cluster 110 is moving in one direction and one or more of the compute devices 100 is moving in a different direction. In the illustrative embodiment, the primary compute device 102 is a wearable device (i.e., attached to the user). Accordingly, if the primary compute device 102 is moving away from the secondary compute devices 104, 106, 108, this may be indicative of the user accidentally leaving the secondary compute devices 104, 106, 108 behind. However, if one of the secondary compute devices 104, 106, 108 is moving away from the cluster 110, this may be indicative of theft. In some embodiments, the primary compute device 102 may deduce a heading from locally generated sensor data.

In block 628, the primary compute device 102 determines an action to take based on whether one or more of the compute devices 100 is moving away from the cluster 110. If the primary compute device 102 determines that none of the compute devices 100 are moving away from the cluster 110, the method 600 loops back to block 624 to again determine whether a compute device 100 is moving away from the cluster 110. In other words, the primary compute device 102 may continually monitor the compute devices 100 to determine whether any of them are moving away from the cluster 110. In some embodiments, the primary compute device 102 may periodically monitor the compute devices 100 on an interval, such as every ten seconds, or other interval, to conserve power. If the primary compute device 102 determines, in block 628, that one or more of the compute devices 100 is moving away from the cluster 110, the method 600 advances to block 630, in which the primary compute device 102 determines the distance between the compute devices 100 of the cluster 110. In the illustrative embodiment, the secondary compute devices 104, 106, 108 are not using power-intensive location sensing devices such as the GPS sensor 212. Accordingly, in the illustrative embodiment, the primary compute device 102 determines the distance based on the motion sensor data, such as by integrating the direction and speed data over the time period beginning when the primary compute device 100 determined that the one or more compute devices 100 is moving away from the cluster 110. In block 632, the primary compute device 102 compares the determined distance to a predefined threshold distance, such as five feet.

In block 634, the primary compute device 102 determines whether the determined distance from block 630 satisfies the threshold distance (e.g., is equal to or greater than the threshold distance). By performing this determination, the primary compute device 102 may eliminate false positives in which one or more of the compute devices 100 are still within arm's reach of the user and is likely being moved by the user rather than being stolen or left behind. If the threshold distance is not satisfied, the method 600 loops back to block 628 to again determine whether the one or more compute devices 100 are moving away from the cluster 110 and, if so, re-determine the distance. However, if the primary compute device 102 determines, in block 634, that the threshold distance has been satisfied, the method 600 advances to block 636, in which the primary compute device 102 generates a notification to the user of the primary compute device 102 that one or more of the compute devices 100 has been separated from the cluster 110. In doing so, the primary compute device 102 may generate a visual notification, as indicated in block 638. Additionally or alternatively, the primary compute device 102 may generate an audible notification and/or a tactile notification, as indicated in block 640 and 642, respectively.

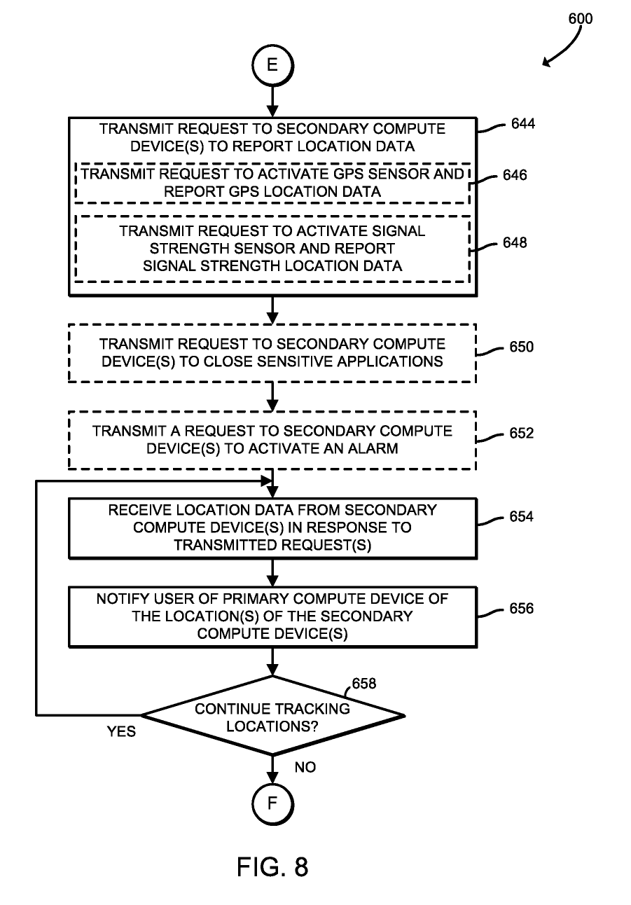

In block 644 of FIG. 8, the primary compute device 102 transmits a request to one or more of the secondary compute devices 104, 106, 108 (i.e., the secondary compute devices 104, 106, 108 that are no longer within the threshold distance of the primary compute device 102) to report location data. In doing so, the primary compute device 102 may transmit a request to activate the GPS sensor 212 and report GPS location data, as indicated in block 646. Additionally or alternatively, the primary compute device 102 may transmit a request to activate the signal strength sensor 214 and report signal strength location data, as indicated in block 648. In other words, regardless of whether the primary compute device 102 has moved away from the stationary secondary compute devices 104, 106, 108 or one or more of the secondary compute devices 104, 106, 108 has moved away from the primary device, or any other scenario in which one or more of the secondary compute devices 104, 106, 108 is no longer within the threshold distance of the primary compute device 102, the primary compute device 102 will request the separated secondary compute device(s) to report their location data.

In block 650, the primary compute device 102 may transmit a request to separated (i.e., outside of the threshold distance) secondary compute devices 104, 106, 108 to close sensitive applications that may otherwise provide sensitive information to a thief or other person. In block 652, the primary compute device 102 may transmit a request to the separated secondary compute devices 104, 106, 108 to activate an alarm, such as an audible alarm. By activating an alarm, a secondary compute device 104, 106, 108 may make its location more apparent and/or prompt a thief to discard the secondary compute device 104, 106, 108 to avoid drawing attention to himself or herself. In block 654, the primary compute device 102 receives location data from the separated secondary compute devices 104, 106, 108 in response to the request transmitted in block 644. In block 656, the primary compute device 102 notifies the user of the reported locations of the secondary compute devices 104, 106, 108 to enable their recovery. In block 658, the primary compute device 102 determines whether to continue tracking the locations of the secondary compute devices 104, 106, 108. For example, the primary compute device 102 may determine that the secondary compute devices 104, 106, 108 are now back within the threshold distance of the primary compute device 102, may receive an indication from the user to stop tracking the locations because the user wishes to stop the process (e.g., because the user recovered the secondary compute devices 104, 106, 108), or may make the determination to stop tracking the locations for another reason. If the primary compute device 102 determines not to continue tracking the locations, the method 600 loops back to block 602 in which the primary compute device 102 again determines whether to monitor the compute devices 100. Otherwise, the method 600 loops back to block 654 to receive additional location data from the secondary compute devices 104, 106, 108 and continue notifying the user of their locations.

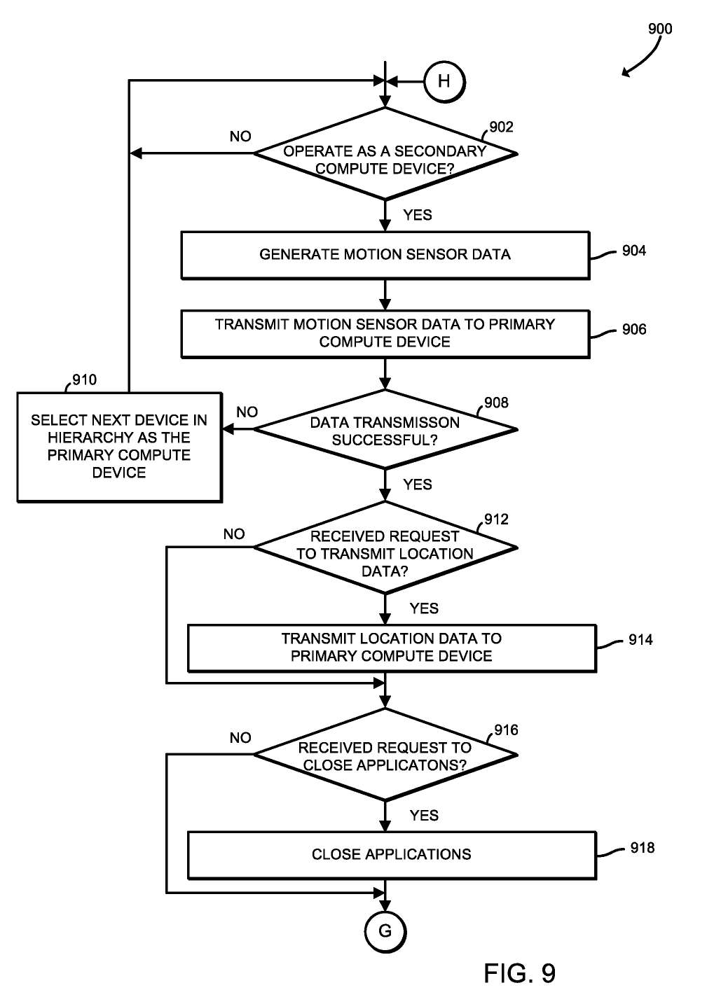

Referring now to FIG. 9, in use, a compute device 100 of the cluster 110 may perform a method 900 of operating as a secondary compute device 104, 106, 108. The method 900 begins with block 902 in which the compute device 100 determines whether to operate as a secondary compute device 104, 106, 108. For example, the compute device 100 may reference the established hierarchy, contained within the cluster membership data 302, and determine that it is designated as a secondary compute device. In other embodiments, the compute device 100 may determine to operate as a secondary compute device in response to an input received from a user of the compute device 100 or based on other factors. Regardless, if the compute device 100 determines to operate as a secondary device, the method 900 advances to block 904 in which the compute device 100 generates motion sensor data using the one or more motion sensors 210. As described above, the illustrative motion sensor data includes information on the direction of movement of the compute device 100 in three dimensions, as well as the speed of the movement.

In block 906, the compute device 100 transmits the generated motion sensor data and/or a determined heading to the primary compute device 102. In block 908, the compute device 100 determines whether the motion sensor data was successfully transmitted to the primary compute device 102. For example, the compute device 100 may await an acknowledgement message from the primary compute device 102 in response to the transmission of the motion sensor data and, if a predefined amount of time elapses without an acknowledgement message, the compute device 100 may determine that the data transmission was unsuccessful. In other embodiments, the compute device 100 may determine whether the data transmission was successful based on other factors. Regardless, if the compute device 100 determines that the data transmission was unsuccessful, the method 900 advances to block 910, in which the compute device 100 selects the next compute device in the hierarchy as the primary compute device and the method 900 loops back to block 902, in which the compute device 100 determines whether to operate as a secondary compute device. In other words, the compute device 100 may determine that the present primary compute device 102 is inoperative (e.g., due to a drained battery), and may select the next compute device 100 in the established hierarchy as the primary compute device 102. As should be appreciated, it is possible that the compute device 100 is the next compute device 100 to operate as the primary compute device 102, in which case the determination in block 902 would be no.

Referring back to block 908, if the compute device 100 instead determines that the data transmission was successful, the method 900 advances to block 912, in which the compute device 100 determines whether it has received a request to transmit location data to the primary compute device 102 (i.e., the compute device 100 is no longer within the threshold distance of the primary compute device 102). If so, the method 900 advances to block 914, in which the compute device 102 transmits the location data to the primary compute device 102. In doing so, the compute device 100 may first activate the GPS sensor 212, the signal strength sensor 214, and/or other location determination sensors in order to generate the location data. Referring back to block 912, if the compute device 100 has not received a request to transmit location data, the method 900 advances to block 916 in which the compute device 100 determines whether it has received a request to close one or more applications running on the compute device 100. As described above, if the compute device 100 has become separated from the primary compute device 102 by at least the threshold distance, then the primary compute device 102 may transmit a request to the compute device 100 to close one or more applications that may otherwise reveal sensitive information to people other than the owner of the compute device 100. If the compute device 100 determines that it has received such a request, the method 900 advances to block 918 in which the compute device 100 closes the applications.

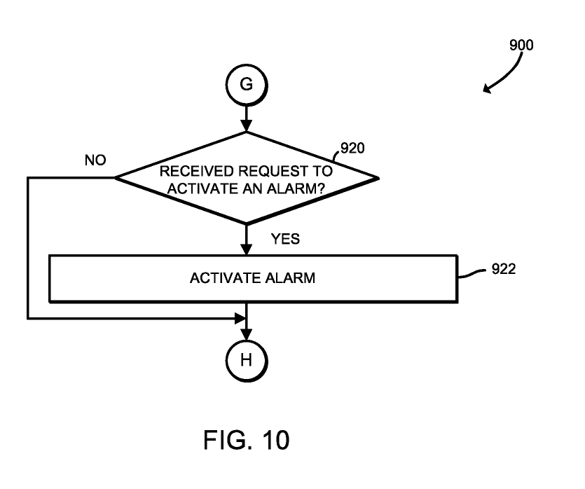

Subsequently, the method 900 advances to block 920 of FIG. 10 in which the compute device 100 determines whether it has received a request from the primary compute device 102 to activate an alarm. If so, the compute device activates an alarm, as indicated in block 922. As described above, the alarm may be useful in enabling the owner of the compute device 100 to find the compute device 100 and/or may prompt a thief to discard the compute device 100. If, in block 920, the compute device 100 determines that such a request was not received, or subsequent to activating the alarm in block 922, the method 900 loops back to block 902 of FIG. 9 in which the compute device 100 again determines whether to operate as a secondary compute device. In other words, the illustrative compute device 100 is configured to continually re-determine whether it is to operate as a secondary compute device.

### EXAMPLES

Illustrative examples of the technologies disclosed herein are provided below. An embodiment of the technologies may include any one or more, and any combination of, the examples described below.

Example 1 includes a compute device comprising a network communication module to receive motion sensor data from at least one secondary compute device of a cluster, wherein the cluster comprises a plurality of compute devices that includes the at least one secondary compute device and the compute device, and wherein the compute device is a primary compute device of the cluster; a context management module to determine, based on the motion sensor data, whether one or more compute devices of the cluster has moved away from the cluster; and a notification module to notify, in response to a determination that the one or more compute devices of the cluster has moved away from the cluster, a user of the compute device that the one or more compute devices has moved away from the cluster.

Example 2 includes the subject matter of Example 1, and wherein the context management module is further to determine whether the compute device is within a predefined safe zone; and wherein to determine whether the one or more compute devices of the cluster has moved away from the cluster comprises to determine, in response to a determination that the compute device is not in the predefined safe zone, whether the one or more compute devices of the cluster has moved away from the cluster.

Example 3 includes the subject matter of any of Examples 1 and 2, and wherein to determine whether the compute device is within a predefined safe zone comprises to compare present geographic coordinates of the compute device to predefined geographic coordinates associated with the predefine safe zone.

Example 4 includes the subject matter of any of Examples 1-3, and wherein to determine whether the compute device is within a predefined safe zone comprises to detect a network identifier associated with a present location of the compute device; and compare the detected network identifier to a predefined wireless network identifier associated with the predefined safe zone.

Example 5 includes the subject matter of any of Examples 1-4, and wherein to determine whether the compute device is within a predefined safe zone comprises to detect a vehicle network identifier associated with a present location of the compute device; and compare the detected vehicle network identifier to a predefined vehicle network identifier associated with the predefined safe zone.

Example 6 includes the subject matter of any of Examples 1-5, and wherein the context management module is further to determine whether the one or more compute devices of the cluster has moved away by a threshold distance; and wherein to notify the user comprises to notify the user in response to a determination that the one or more compute devices of the cluster has moved away from the cluster by at least the threshold distance.

Example 7 includes the subject matter of any of Examples 1-6, and wherein the network communication module is further to (i) transmit a request to the one or more compute devices that has moved away from the cluster to report location data, and (ii) receive the location data from the one or more compute devices; and the notification module is further to notify the user of locations of the one or more compute devices that have moved away from the cluster, based on the location data.

Example 8 includes the subject matter of any of Examples 1-7, and wherein the network communication module is further to transmit a request to the one or more compute devices that has moved away from the cluster to close one or more applications.

Example 9 includes the subject matter of any of Examples 1-8, and wherein the network communication module is further to transmit a request to the one or more compute devices that has moved away from the cluster to activate an alarm.

Example 10 includes the subject matter of any of Examples 1-9, and wherein to determine whether one or more compute devices of the cluster has moved away from the cluster comprises to determine that the primary compute device has remained stationary and that at least one of the secondary devices has moved away from the cluster.

Example 11 includes the subject matter of any of Examples 1-10, and wherein to determine whether one or more of the compute devices of the cluster has moved away from the cluster comprises to determine that the primary compute device has moved away from the cluster and that at least one of the secondary devices has remained stationary.

Example 12 includes the subject matter of any of Examples 1-11, and wherein the context management module is further to determine that the compute device is to operate as a secondary compute device and that another compute device of the cluster is the primary compute device; and the network communication device is further to transmit motion sensor data associated with the compute device to the primary compute device of the cluster.

Example 13 includes a communication module is further to receive a request from the primary compute device to close one or more applications; and the notification module is further to close the one or more applications.

Example 14 includes the subject matter of Example 13 wherein the communication module is further to receive a request from the primary compute device to activate an alarm; and the notification module is further to activate, in response to the request, the alarm.

Example 15 includes the subject matter of any of Examples 13 and 14, and wherein the communication module is further to receive a request from the primary compute device to report location data; the context management module is further to generate location data based on one or more of global positioning system (GPS) location data or wireless signal strength location data; and the communication module is further to transmit the location data to the primary compute device.

Example 16 includes the subject matter of any of Examples 13-15, and wherein the context management module is further to determine whether the compute device is within a predefined safe zone based on a semantic context of the compute device.

Example 17 includes a method comprising receiving, by a compute device, motion sensor data from at least one secondary compute device of a cluster, wherein the cluster comprises a plurality of compute devices that includes the at least one secondary compute device and the compute device, and wherein the compute device is a primary compute device of the cluster; determining, by the compute device and based on the motion sensor data, whether one or more compute devices of the cluster has moved away from the cluster; and notifying, by the compute device and in response to a determination that the one or more compute devices of the cluster has moved away from the cluster, a user of the compute device that the one or more compute devices has moved away from the cluster.

Example 18 includes the subject matter of any of Example 17, and further including determining whether the compute device is within a predefined safe zone; and wherein determining whether the one or more compute devices of the cluster has moved away from the cluster comprises determining, in response to a determination that the compute device is not in the predefined safe zone, whether the one or more compute devices of the cluster has moved away from the cluster.

Example 19 includes the subject matter of any of Examples 17 and 18, and wherein determining whether the compute device is within a predefined safe zone comprises comparing present geographic coordinates of the compute device to predefined geographic coordinates associated with the predefine safe zone.

Example 20 includes the subject matter of any of Examples 17-19, and wherein determining whether the compute device is within a predefined safe zone comprises detecting a network identifier associated with a present location of the compute device; and comparing the detected network identifier to a predefined wireless network identifier associated with the predefined safe zone.

Example 21 includes the subject matter of any of Examples 17-20, and wherein determining whether the compute device is within a predefined safe zone comprises detecting a vehicle network identifier associated with a present location of the compute device; and comparing the detected vehicle network identifier to a predefined vehicle network identifier associated with the predefined safe zone.

Example 22 includes the subject matter of any of Examples 17-21, and further including determining, by the compute device, whether the one or more compute devices of the cluster has moved away by a threshold distance; and wherein notifying the user comprises notifying the user in response to a determination that the one or more compute devices of the cluster has moved away from the cluster by at least the threshold distance.

Example 23 includes the subject matter of any of Examples 17-22, and further including transmitting, by the compute device, a request to the one or more compute devices that has moved away from the cluster to report location data; receiving, by the compute device, the location data from the one or more compute devices; and notifying, by the compute device, the user of locations of the one or more compute devices that have moved away from the cluster, based on the location data.

Example 24 includes the subject matter of any of Examples 17-23, and further including transmitting, by the compute device, a request to the one or more compute devices that has moved away from the cluster to close one or more applications.

Example 25 includes the subject matter of any of Examples 17-24, and further including transmitting, by the compute device, a request to the one or more compute devices that has moved away from the cluster to activate an alarm.

Example 26 includes the subject matter of any of Examples 17-25, and wherein determining whether one or more compute devices of the cluster has moved away from the cluster comprises determining that the primary compute device has remained stationary and that at least one of the secondary devices has moved away from the cluster.

Example 27 includes the subject matter of any of Examples 17-26, and wherein determining whether one or more of the compute devices of the cluster has moved away from the cluster comprises determining that the primary compute device has moved away from the cluster and that at least one of the secondary devices has remained stationary.

Example 28 includes the subject matter of any of Examples 17-27, and further including determining, by the compute device, that the compute device is to operate as a secondary compute device and that another compute device of the cluster is the primary compute device; and transmitting, by the compute device, motion sensor data associated with the compute device to the primary compute device of the cluster.

Example 29 includes the subject matter of any of Examples 17-28, and further including receiving, by the compute device, a request from the primary compute device to close one or more applications; and closing, by the compute device, the one or more applications.

Example 30 includes the subject matter of any of Examples 17-29, and further including receiving, by the compute device, a request from the primary compute device to activate an alarm; and activating, by the compute device and in response to the request, the alarm.

Example 31 includes the subject matter of any of Examples 17-30, and further including receiving, by the compute device, a request from the primary compute device to report location data; generating, by the compute device, location data based on one or more of global positioning system (GPS) location data or wireless signal strength location data; and transmitting, by the compute device, the location data to the primary compute device.

Example 32 includes one or more computer-readable storage media comprising a plurality of instructions that, when executed, cause a compute device to perform the method of any of Examples 17-31.

Example 33 includes a compute device comprising means for receiving motion sensor data from at least one secondary compute device of a cluster, wherein the cluster comprises a plurality of compute devices that includes the at least one secondary compute device and the compute device, and wherein the compute device is a primary compute device of the cluster; means for determining, based on the motion sensor data, whether one or more compute devices of the cluster has moved away from the cluster; and means for notifying, in response to a determination that the one or more compute devices of the cluster has moved away from the cluster, a user of the compute device that the one or more compute devices has moved away from the cluster.

Example 34 includes the subject matter of any of Example 33, and further including means for determining whether the compute device is within a predefined safe zone; and wherein the means for determining whether the one or more compute devices of the cluster has moved away from the cluster comprises means for determining, in response to a determination that the compute device is not in the predefined safe zone, whether the one or more compute devices of the cluster has moved away from the cluster.

Example 35 includes the subject matter of any of Examples 33 and 34, and wherein the means for determining whether the compute device is within a predefined safe zone comprises means for comparing present geographic coordinates of the compute device to predefined geographic coordinates associated with the predefine safe zone.

Example 36 includes the subject matter of any of Examples 33-35, and wherein the means for determining whether the compute device is within a predefined safe zone comprises means for detecting a network identifier associated with a present location of the compute device; and means for comparing the detected network identifier to a predefined wireless network identifier associated with the predefined safe zone.

Example 37 includes the subject matter of any of Examples 33-36, and wherein the means for determining whether the compute device is within a predefined safe zone comprises means for detecting a vehicle network identifier associated with a present location of the compute device; and means for comparing the detected vehicle network identifier to a predefined vehicle network identifier associated with the predefined safe zone.

Example 38 includes the subject matter of any of Examples 33-37, and further including means for determining whether the one or more compute devices of the cluster has moved away by a threshold distance; and wherein the means for notifying the user comprises means for notifying the user in response to a determination that the one or more compute devices of the cluster has moved away from the cluster by at least the threshold distance.

Example 39 includes the subject matter of any of Examples 33-38, and further including means for transmitting a request to the one or more compute devices that has moved away from the cluster to report location data; means for receiving the location data from the one or more compute devices; and means for notifying the user of locations of the one or more compute devices that have moved away from the cluster, based on the location data.

Example 40 includes the subject matter of any of Examples 33-9, and further including means for transmitting a request to the one or more compute devices that has moved away from the cluster to close one or more applications.

Example 41 includes the subject matter of any of Examples 33-40, and further including means for transmitting a request to the one or more compute devices that has moved away from the cluster to activate an alarm.

Example 42 includes the subject matter of any of Examples 33-41, and wherein the means for determining whether one or more compute devices of the cluster has moved away from the cluster comprises means for determining that the primary compute device has remained stationary and that at least one of the secondary devices has moved away from the cluster.

Example 43 includes the subject matter of any of Examples 33-42, and wherein the means for determining whether one or more of the compute devices of the cluster has moved away from the cluster comprises means for determining that the primary compute device has moved away from the cluster and that at least one of the secondary devices has remained stationary.

Example 44 includes the subject matter of any of Examples 33-43, and further including means for determining that the compute device is to operate as a secondary compute device and that another compute device of the cluster is the primary compute device; and means for transmitting motion sensor data associated with the compute device to the primary compute device of the cluster.

Example 45 includes the subject matter of any of Examples 33-44, and further including means for receiving a request from the primary compute device to close one or more applications; and means for closing the one or more applications.

Example 46 includes the subject matter of any of Examples 33-45, and further including means for receiving a request from the primary compute device to activate an alarm; and means for activating, in response to the request, the alarm.

Example 47 includes the subject matter of any of Examples 33-46, and further including means for receiving a request from the primary compute device to report location data; means for generating location data based on one or more of global positioning system (GPS) location data or wireless signal strength location data; and means for transmitting the location data to the primary compute device.

Example 48 includes a compute device comprising a context management module to (i) generate motion sensor data and (ii) determine that the compute device is to operate as a secondary compute device of a cluster, wherein the cluster comprises a plurality of compute devices that includes at least the compute device and a primary compute device, and that another compute device of the cluster is the primary compute device; and a network communication device to transmit the motion sensor data associated with the compute device to the primary compute device of the cluster.

Example 49 includes the subject matter of Example 48, and wherein the communication module is further to receive a request from the primary compute device to close one or more applications; and the compute device further comprises a notification module to close the one or more applications.

Example 50 includes the subject matter of Examples 48 and 49, and wherein the communication module is further to receive a request from the primary compute device to activate an alarm; and the compute device further comprises a notification module to activate, in response to the request, the alarm.

Example 50 includes the subject matter of Examples 48-50, and wherein the communication module is further to receive a request from the primary compute device to report location data; the context management module is further to generate location data based on one or more of global positioning system (GPS) location data or wireless signal strength location data; and the communication module is further to transmit the location data to the primary compute device.

Example 52 includes a method comprising generating, by a compute device, motion sensor data; determining, by the compute device, that the compute device is to operate as a secondary compute device of a cluster, wherein the cluster comprises a plurality of compute devices that includes at least the compute device and a primary compute device, and that another compute device of the cluster is the primary compute device; and transmitting, by the compute device, the motion sensor data associated with the compute device to the primary compute device of the cluster.

Example 53 includes the subject matter of Example 52, and further including receiving, by the compute device, a request from the primary compute device to close one or more applications; and closing, by the compute device, the one or more applications.

Example 54 includes the subject matter of Examples 52 and 53, and further including receiving, by the compute device, a request from the primary compute device to activate an alarm; and activating, by the compute device and in response to the request, the alarm.

Example 55 includes the subject matter of Examples 52-54, and further including receiving, by the compute device, a request from the primary compute device to report location data; generating, by the compute device, location data based on one or more of global positioning system (GPS) location data or wireless signal strength location data; and transmitting, by the compute device, the location data to the primary compute device.

Example 56 includes one or more computer-readable storage media comprising a plurality of instructions that, when executed, cause a compute device to perform the method of any of Examples 52-55.

Example 57 includes a compute device comprising means for generating motion sensor data; means for determining that the compute device is to operate as a secondary compute device of a cluster, wherein the cluster comprises a plurality of compute devices that includes at least the compute device and a primary compute device, and that another compute device of the cluster is the primary compute device; and means for transmitting the motion sensor data associated with the compute device to the primary compute device of the cluster.

Example 58 includes the subject matter of Example 57, and further including means for receiving a request from the primary compute device to close one or more applications; and means for closing the one or more applications.

Example 59 includes the subject matter of Examples 57 and 58, and further including means for receiving a request from the primary compute device to activate an alarm; and means for activating, in response to the request, the alarm.

Example 60 includes the subject matter of Examples 57-59, and further including means for receiving a request from the primary compute device to report location data; means for generating location data based on one or more of global positioning system (GPS) location data or wireless signal strength location data; and means for transmitting the location data to the primary compute device.

1. A compute device comprising:
a network communication module to receive motion sensor data from at least one secondary compute device of a cluster, wherein the cluster comprises a plurality of compute devices that includes the at least one secondary compute device and the compute device, and wherein the compute device is a primary compute device of the cluster;
a context management module to determine, based on the motion sensor data, whether one or more compute devices of the cluster has moved away from the cluster; and
a notification module to notify, in response to a determination that the one or more compute devices of the cluster has moved away from the cluster, a user of the compute device that the one or more compute devices has moved away from the cluster.

2. The compute device of claim 1, wherein the context management module is further to determine whether the compute device is within a predefined safe zone; and
wherein to determine whether the one or more compute devices of the cluster has moved away from the cluster comprises to determine, in response to a determination that the compute device is not in the predefined safe zone, whether the one or more compute devices of the cluster has moved away from the cluster.

3. The compute device of claim 2, wherein to determine whether the compute device is within a predefined safe zone comprises to compare present geographic coordinates of the compute device to predefined geographic coordinates associated with the predefine safe zone.

4. The compute device of claim 2, wherein to determine whether the compute device is within a predefined safe zone comprises to:
detect a network identifier associated with a present location of the compute device; and
compare the detected network identifier to a predefined wireless network identifier associated with the predefined safe zone.

5. The compute device of claim 2, wherein to determine whether the compute device is within a predefined safe zone comprises to:
detect a vehicle network identifier associated with a present location of the compute device; and
compare the detected vehicle network identifier to a predefined vehicle network identifier associated with the predefined safe zone.

6. The compute device of claim 1, wherein the context management module is further to determine whether the one or more compute devices of the cluster has moved away by a threshold distance; and
wherein to notify the user comprises to notify the user in response to a determination that the one or more compute devices of the cluster has moved away from the cluster by at least the threshold distance.

7. The compute device of claim 1, wherein:
the network communication module is further to (i) transmit a request to the one or more compute devices that has moved away from the cluster to report location data, and (ii) receive the location data from the one or more compute devices; and
the notification module is further to notify the user of locations of the one or more compute devices that have moved away from the cluster, based on the location data.

8. The compute device of claim 1, wherein the network communication module is further to transmit a request to the one or more compute devices that has moved away from the cluster to close one or more applications.

9. The compute device of claim 1, wherein the network communication module is further to transmit a request to the one or more compute devices that has moved away from the cluster to activate an alarm.

10. One or more computer-readable storage media comprising a plurality of instructions that, when executed, cause a compute device to:
receive motion sensor data from at least one secondary compute device of a cluster, wherein the cluster comprises a plurality of compute devices that includes the at least one secondary compute device and the compute device, and wherein the compute device is a primary compute device of the cluster;
determine, based on the motion sensor data, whether one or more compute devices of the cluster has moved away from the cluster; and
notify, in response to a determination that the one or more compute devices of the cluster has moved away from the cluster, a user of the compute device that the one or more compute devices has moved away from the cluster.

11. The one or more computer-readable storage media of claim 10, further comprising instructions that, when executed, cause the compute device to determine whether the compute device is within a predefined safe zone; and
wherein to determine whether the one or more compute devices of the cluster has moved away from the cluster comprises to determine, in response to a determination that the compute device is not in the predefined safe zone, whether the one or more compute devices of the cluster has moved away from the cluster.

12. The one or more computer-readable storage media of claim 11, wherein to determine whether the compute device is within a predefined safe zone comprises to compare present geographic coordinates of the compute device to predefined geographic coordinates associated with the predefined safe zone.

13. The one or more computer-readable storage media of claim 11, wherein to determine whether the compute device is within a predefined safe zone comprises:
to detect a network identifier associated with a present location of the compute device; and
to compare the detected network identifier to a predefined wireless network identifier associated with the predefined safe zone.

14. The one or more computer-readable storage media of claim 11, wherein to determine whether the compute device is within a predefined safe zone comprises:
to detect a vehicle network identifier associated with a present location of the compute device; and
to compare the detected vehicle network identifier to a predefined vehicle network identifier associated with the predefined safe zone.

15. The one or more computer-readable storage media of claim 10, further comprising instructions that, when executed, cause the compute device to determine whether the one or more compute devices of the cluster has moved away by a threshold distance; and
wherein to notify the user comprises to notify the user in response to a determination that the one or more compute devices of the cluster has moved away from the cluster by at least the threshold distance.

16. The one or more computer-readable storage media of claim 10, further comprising instructions that, when executed, cause the compute device to:
transmit a request to the one or more compute devices that has moved away from the cluster to report location data;
receive the location data from the one or more compute devices; and
notify the user of locations of the one or more compute devices that have moved away from the cluster, based on the location data.

17. The one or more computer-readable storage media of claim 10, further comprising instructions that, when executed, cause the compute device to transmit a request to the one or more compute devices that has moved away from the cluster to close one or more applications.

18. A method comprising:
receiving, by a compute device, motion sensor data from at least one secondary compute device of a cluster, wherein the cluster comprises a plurality of compute devices that includes the at least one secondary compute device and the compute device, and wherein the compute device is a primary compute device of the cluster;
determining, by the compute device and based on the motion sensor data, whether one or more compute devices of the cluster has moved away from the cluster; and
notifying, by the compute device and in response to a determination that the one or more compute devices of the cluster has moved away from the cluster, a user of the compute device that the one or more compute devices has moved away from the cluster.

19. The method of claim 18, further comprising determining whether the compute device is within a predefined safe zone; and
wherein determining whether the one or more compute devices of the cluster has moved away from the cluster comprises determining, in response to a determination that the compute device is not in the predefined safe zone, whether the one or more compute devices of the cluster has moved away from the cluster.

20. The method of claim 19, wherein determining whether the compute device is within a predefined safe zone comprises comparing present geographic coordinates of the compute device to predefined geographic coordinates associated with the predefine safe zone.

21. The method of claim 19, wherein determining whether the compute device is within a predefined safe zone comprises:
detecting a network identifier associated with a present location of the compute device; and
comparing the detected network identifier to a predefined wireless network identifier associated with the predefined safe zone.

22. The method of claim 19, wherein determining whether the compute device is within a predefined safe zone comprises:
detecting a vehicle network identifier associated with a present location of the compute device; and
comparing the detected vehicle network identifier to a predefined vehicle network identifier associated with the predefined safe zone.

23. The method of claim 18, further comprising determining, by the compute device, whether the one or more compute devices of the cluster has moved away by a threshold distance; and
wherein notifying the user comprises notifying the user in response to a determination that the one or more compute devices of the cluster has moved away from the cluster by at least the threshold distance.

24. The method of claim 18, further comprising:
transmitting, by the compute device, a request to the one or more compute devices that has moved away from the cluster to report location data;
receiving, by the compute device, the location data from the one or more compute devices; and
notifying, by the compute device, the user of locations of the one or more compute devices that have moved away from the cluster, based on the location data.

25. The method of claim 18, further comprising transmitting, by the compute device, a request to the one or more compute devices that has moved away from the cluster to close one or more applications.
